(19) United States
(12) Patent Application Publication
(10) Pub. No.: US 2024/0163095 A1
(43) Pub. Date: May 16, 2024

(54) IMMUTABLE AND SECURE OFF-CHAIN STORAGE FOR BLOCKCHAIN APPLICATIONS

(71) Applicant: Druva Inc., Santa Clara, CA (US)

(72) Inventors: Jaspreet Singh, Saratoga, CA (US); Preethi Srinivasan, Sunnyvale, CA (US)

(21) Appl. No.: 17/986,653

(22) Filed: Nov. 14, 2022

(51) Int. Cl. H04L 9/14; H04L 9/00

(52) U.S. Cl. CPC H04L 9/14; H04L 9/50

(57) ABSTRACT

A data management server may receive data associated with a blockchain unit generated on a blockchain. The data received may include on-chain data and off-chain data. The data management server may create a data collection associated with the blockchain unit. The data collection may include the received data that is stored in one or more entries of transactions associated with the blockchain unit. One of the entries of transactions may include the on-chain data that is stored on the blockchain. The data management server may store, off-chain, the data collection associated with the blockchain unit. The data management server may generate an off-chain address for a user to retrieve the data collection. The off-chain address allows the user to review one of the entries of transactions off-chain. The off-chain address may be a global namespace that can be accessed without a particular system or file structure

### FIELD

This application relates to collecting data in a distributed system to a centralized system, and more specifically, to aggregating data in the distributed system with other data sources to generate a centralized collection of data.

### BACKGROUND

Blockchain units are often generated by decentralized applications and use a blockchain data structure to store digital data and metadata on the blockchain. The digital data is stored on the chain for authenticating transactions providing the verifiability of the transactions due to their immutability and decentralization. To verify these transactions, various explorers, APIs, and adapters are available but these tools are centralized or chain-dependent. Some off-chain distributed systems may be used to address centralized storage problems but the distributed systems also have their drawback such as content-dependent addresses that may lack flexibility. Moreover, blockchain units are often associated with various peripheral operations for record management such as author, art details, smart contract details, etc. Metadata and a complete history of a blockchain unit are often hard to search and retrieve due to the nature of the blockchain.

### BRIEF DESCRIPTION OF THE DRAWINGS

FIG. 1 is an example system environment, in accordance with some embodiments.

FIG. 2 is a block diagram representing an example data management server, in accordance with some embodiments.

FIG. 3 is a flowchart depicting an example process for generating a data collection associated with a blockchain unit, in accordance with some embodiments.

FIG. 4 is a block diagram that conceptually illustrates the migration of data and generation of data collections, in accordance some embodiments.

FIG. 5 is a conceptual diagram illustrating an example of a data collection under a namespace, in accordance with some embodiments.

FIG. 6 is a sequence diagram illustrating an example series of interactions among entities of the system environment 100 to generate data collection for a blockchain unit, in accordance with some embodiments.

FIG. 7A is a block diagram illustrating a chain of transactions broadcasted and recorded on a blockchain, in accordance with an embodiment.

FIG. 7B is a block diagram illustrating a connection of multiple blocks in a blockchain, in accordance with an embodiment.

FIG. 8 is a block diagram illustrating components of an example computing machine that is capable of reading instructions from a computer-readable medium and executing them in a processor.

The figures depict, and the detail description describes, various non-limiting embodiments for purposes of illustration only.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

In Various Embodiments Described Herein, a Data Management Server May Transfer On-chain data to off-chain so that data becomes chain agnostic, thus bringing advantages of various services available off-chain and reducing chain compute, storage, and mining dependency. The data associated with a blockchain unit may be collected from different data sources, whether on-chain or off-chain. The collected data may be stored on the Cloud to provide resilient and scalable infrastructure. Aggregating on-chain and off-chain data on the Cloud provides the advantage of cloud services and capabilities such as replication, scaling, analytics, indexing, and caching. In some embodiments, the data entry records may be stored as Cloud agnostic InterPlanetary File System (IPFS) Uniform Resource Locators (URLs).

The file system provides peer-to-peer distribution of the data to complement the decentralized nature of the applications. The permanent name translations are agnostic of the underlying cloud storage model. The use of IPFS to store data records may also provide a permanent record of the data at that point in time. IPFS facilitates metadata and storage immutability. In some embodiments, the data collection may be put under a global namespace so that even if the physical storage is changed, the URL to the namespace may remain the same. In some embodiments, the system provides security features for specific public and private capabilities for searchability and access.

### System Overview

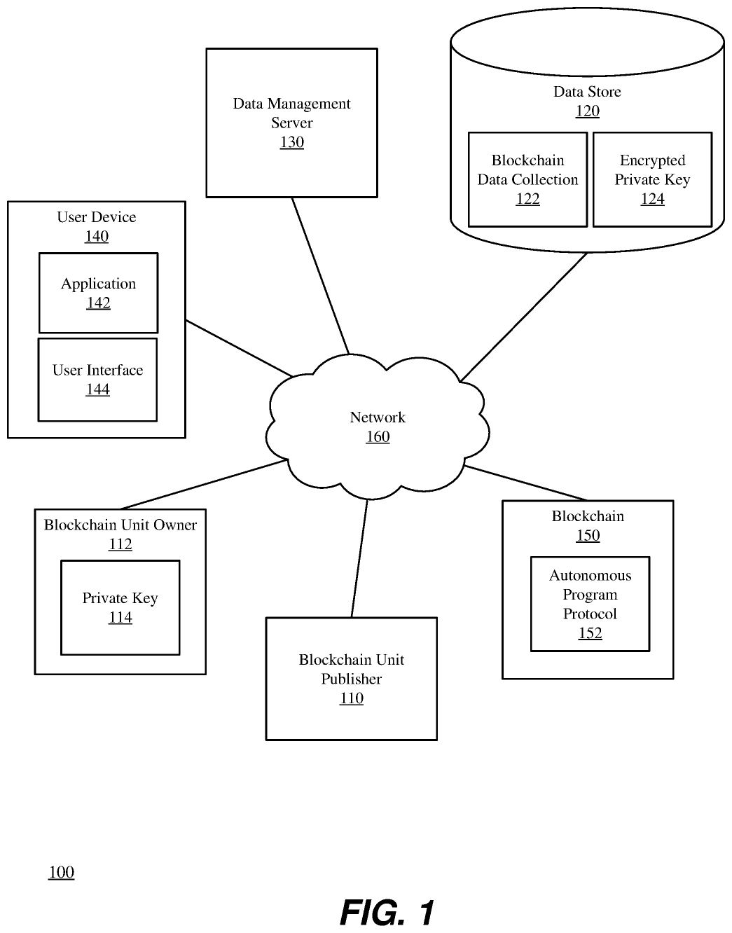

FIG. (FIG. 1 is a block diagram that illustrates a system environment 100 for an off-chain cloud storage system for data related to blockchain units, in accordance with an embodiment. By way of example, the system environment 100 includes a blockchain unit publisher 110, a blockchain unit owner 112, a data store 120, a data management server 130, a user device 140, and a blockchain 150. The entities and components in the system environment 100 communicate with each other through the network 160. In various embodiments, the system environment 100 may include different, fewer, or additional components. The components in the blockchain system environment 100 may each correspond to a separate and independent entity or may be controlled by the same entity. For example, in some embodiments, the data management server 130 may control the data store 120. In some embodiments, the data management server 130 and the data store 120 are controlled by different entities. For example, the data store 120 may be a distributed system such as an InterPlanetary File System (IPFS).

While each of the components in the system environment 100 is often described in disclosure in a singular form, the system environment 100 may include one or more of each of the components. For example, there can be multiple user devices 140 communicating with the data management server 130 and the blockchain 150. Each user device 140 is used by an end user and there can be millions or billions of end users in this system environment 100. Also, the data management server 130 may provide service for multiple blockchain unit publishers 110. While a component is described in a singular form in this disclosure, it should be understood that in various embodiments the component may have multiple instances. Hence, in the system environment 100, there can be one or more of each of the components. Likewise, even if a component is at places described in a plural form, in some embodiments the component may only have a single instance.

A blockchain unit publisher 110 may be an initial publisher that publishes a blockchain unit on a blockchain 150. For example, the blockchain unit publisher 110 may use an autonomous program protocol 152, which may take the form of a smart contract or another type of autonomous algorithm that operates on blockchain 150, to generate the blockchain unit. In various embodiments, blockchain units may take any suitable forms, such as fungible tokens that follow Ethereum ERC-20 standard or another standard, non-fungible tokens (NFT) that follow Ethereum ERC-721 standard or another standard, other forms of blockchain token, applications that are fully or partially executed on a blockchain, such as autonomous applications, Web3 applications, distributed applications, decentralized finance (DeFi) applications, protocols for decentralized autonomous organizations (DAO), etc., and other suitable protocols and algorithms that may be recorded on a blockchain. In the context of NFT, a blockchain unit publisher 110 may be an artist, a content creator, a digital art broker, etc. The blockchain unit publisher 110 may create a unique digital asset (e.g., art, video, music, other content) and create a corresponding NFT through an autonomous program protocol 152 that allows transactions related to the NFT to be tracked and recorded.

While throughout this disclosure NFT may be used as the primary example of the blockchain unit in explaining various embodiments in this disclosure are implemented and applied, the embodiments may also be used for other types of blockchain units such as fungible tokens and Web3 applications.

A blockchain unit owner 112 may be the current owner of the blockchain unit. For example, the blockchain unit publisher 110 may initially create an NFT and the NFT is transferred to subsequent owners. The blockchain unit owner 112 may be the current owner and may possess a private key 114. The cryptographic private key 114 may be used to access the underlying asset of the NFT through a double private key envelope encryption that will be discussed in further detail. The cryptographic private key 114 may be generated through a quantum-resistant encryption algorithm (e.g., with structured lattice, hash function, etc.) to prevent any quantum-based attacks to reverse engineer the key. The private key 114 may be possessed by blockchain unit publisher 110 if the blockchain unit is first launched.

In various embodiments, the cryptographic key generated may be used in various different contexts, depending on the implementations. For example, a cryptographic key may be used for data encryption (e.g., asset encryption), authentication, digital signature, key wrapping, and a master key. The cryptographic private key 114 may include a corresponding public key that may be generated using a standard public-key cryptography method. Specific examples of usage of the cryptographic key may include, but are not limited to, the following. In some embodiments, the cryptographic key may be used as a blockchain wallet for the blockchain 150 for the user to participate in the blockchain 150 directly. In some embodiments, the cryptographic key may be used for encryption in encrypting and accessing the underlying asset of an NFT. In some embodiments, the cryptographic key may be used to log in to any applications in the system environment 100, such as the application 142 or the autonomous program protocol 152. Other examples of usage of the cryptographic key are also possible.

The data store 120 includes one or more storage units such as memory that takes the form of a non-transitory and non-volatile computer storage medium to store various data. The computer-readable storage medium is a medium that does not include a transitory medium such as a propagating signal or a carrier wave. The data store 120 may be used by the data management server 130 to store various data collections of different blockchain units.

In various embodiments, the data store 120 may take different forms. In some embodiments, the data store 120 may be a data storage system that includes a set of architecture and components in forming the data store. For example, data store 120 may be a distributed data storage system such as an IPFS that includes multiple nodes operated by independent entities. In some embodiments, the data store 120 communicates with other components by the network 160. This type of data store 120 may be referred to as a cloud storage server. Examples of cloud storage service providers may include AMAZON AWS, DROPBOX, RACKSPACE CLOUD FILES, AZURE BLOB STORAGE, GOOGLE CLOUD STORAGE, etc. In some embodiments, instead of a cloud storage server, the data store 120 is a storage device that is controlled and connected to the data management server 130. For example, the data store 120 may take the form of memory (e.g., hard drives, flash memory, discs, ROMs, etc.) used by the data management server 130 such as storage devices in a storage server room that is operated by a server.

The data store 120 may use different data storage architectures to manage and arrange the data. For example, in some embodiments, the data store 120 may take the form of an IPFS that distributes data across one or more nodes. The IPFS may generate a unique fingerprint (e.g., a cryptographic hash, checksum) for a block of data. Even if only a small number of bits are changed in the underlying data, the fingerprint could be changed significantly. The unique fingerprint may be referred to as a content identifier (CID). The unique fingerprint may serve as a permanent record of the data at the storage point in time. In some embodiments, the unique fingerprint may also be the address or part of the address for identification and retrieval of the underlying data.

In some embodiments, in addition to or alternatively to using IPFS, the data store 120 may manage data as a file hierarchy or with sectors and tracks. In some embodiments, the data store 120 may take the form of an object storage system, such as AMAZON S3 and AMAZON GLACIER. Object storage (also known as object-based storage) may be a computer data storage architecture that manages data as objects, as opposed to other storage architectures like file storage which manages data as a file hierarchy. Each object may typically include the data of the object itself, a variable amount of metadata of the object, and a unique identifier that identifies the object. The unique identifier may take the form of a fingerprint (e.g., a cryptographic hash, a checksum) of the underlying data of the object itself. In some implementations of objects, once an object is created, normally it could be difficult to be changed even for a single bit. However, unlike files that often need an operating system of a computer to be accessed, objects may often be accessed directly from a data store and/or through API calls. This allows object storage to scale efficiently in light of various challenges in storing data. The data store 120 may also take other suitable forms. For example, the data store 120 may be a relational store such as AMAZON RDS, a key-value store like AMAZON DYNAMODB. In some embodiments, the data store 120 may also include different type of storages. For example, object store such as AMAZON S3 may be used for storing the underlying asset of an NFT while a relational store or a key-value store may be used for storing metadata.

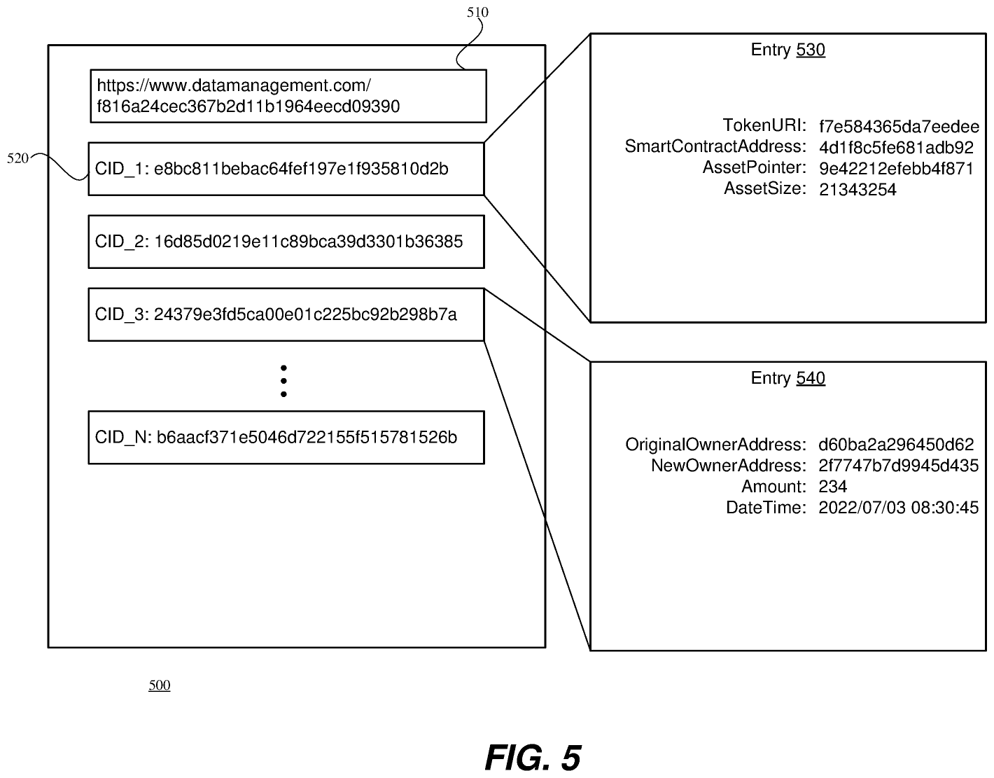

The data store 120 may store a blockchain data collection 122. A data collection 122 may be associated with a particular blockchain unit and may include on-chain data and off-chain data of the particular blockchain unit. In some embodiments, the data collection 122 may include entries of transactions associated with the blockchain unit, metadata of the blockchain unit, the underlying asset, and other suitable information related to the blockchain unit. In some embodiments, the data collection 122 may include asset-related metadata such as the name, description, the token uniform resource identifier (URI), and the token identifier. In some embodiments, the data collection 122 may include transaction metadata such as the owner of the blockchain unit, the transaction metadata such as the current and the new owners, the price of the transaction, the purchase data, transaction identifier, etc. In some embodiments, the data collection 122 may include smart contract metadata such as the contract address, the contract identifier, multisign, etc. In some embodiments, the data collection 122 may include the underlying asset, which may or may not be encrypted. Other metadata may also be stored in the data collection 122, such as a file name, a file header, a timestamp, a version identifier, a file location identifier, a file size, a file directory including timestamp of edit or access dates, ACL checksums, journals including timestamps for change event, etc. An example of data collection 122 is illustrated in further detail in FIG. 5. The data collection 122 may be referred to as a centralized record.

The data collection 122 may include on-chain data and off-chain data. On-chain data are data that is recorded on the blockchain 150. On-chain data may also be data that are stored in a distributed system such as the blockchain 150. Depending on the type of blockchain unit and the implementation choices, typically on-chain data may include metadata stored in the autonomous program protocol 152, transaction records that show a change of ownership of the blockchain unit, and a pointer to a token URI. For example, for an NFT, the pointer may point to an address off-chain that is called the token URI that includes additional metadata of the NFT and the location of the asset. Typically, the asset is stored off-chain via the IPFS, but the precise location of the asset may vary depending on embodiments. Off-chain data are any data that is not stored on the blockchain. On-chain data are still more sparse and expensive because storage of data on a blockchain 150 is often associated with a gas fee of the blockchain 150 that can be relatively expensive compared to a typical Cloud or conventional storage system.

The data store 120 may also store an encrypted private key 124. The encrypted private key 124 may be used for the double private key envelope encryption to encrypt any sensitive information in the blockchain data collection 122. The precise information that may be encrypted may depend on the user's choice or implementation. For example, in some embodiments, the underlying asset of an NFT is encrypted. A first cryptographic private key is generated and used to encrypt the sensitive data. The first cryptographic private key is encrypted by the private key 114 possessed by the blockchain unit owner 112 to generate the encrypted private key 124. The encrypted private key 124 is stored in the data store 120. To retrieve the sensitive data, the blockchain unit owner 112 uses the private key 114 to decrypt the encrypted private key 124. In turn, the decrypted private key 124 is used to decrypt the sensitive data. In the case of a private blockchain, the deployment of the storage model in the data store 120 may be hosted privately for private use.

A data management server 130 may include one or more computing devices that collect data, whether on-chain or off-chain, of various blockchain units, manage the data, create blockchain data collections 122 for storage, and provide a platform for users to review data collections 122 that are related to various blockchain units. The operator of the data management server 130 may provide software platforms (e.g., online platforms), software applications for installation in the client device 140, application programming interfaces (APIs) for clients to manage or view data related to blockchain units, etc. In this disclosure, data management servers 130 may collectively and singularly be referred to as a data management server 130, even though the data management server 130 may include more than one computing device. For example, the data management server 130 may be a pool of computing devices that may be located at the same geographical location (e.g., a server room) or distributed geographically (e.g., cloud computing, distributed computing, or in a virtual server network).

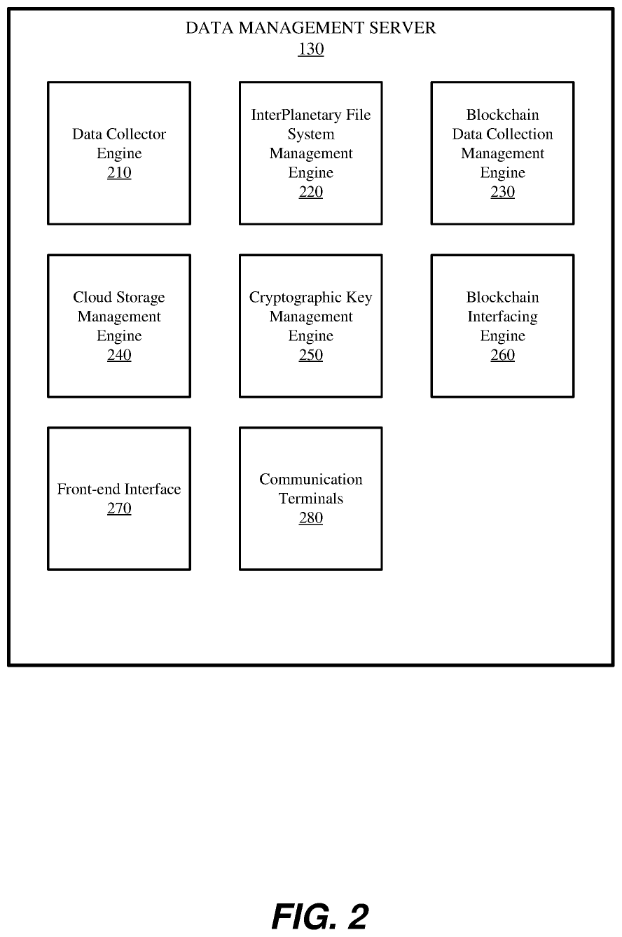

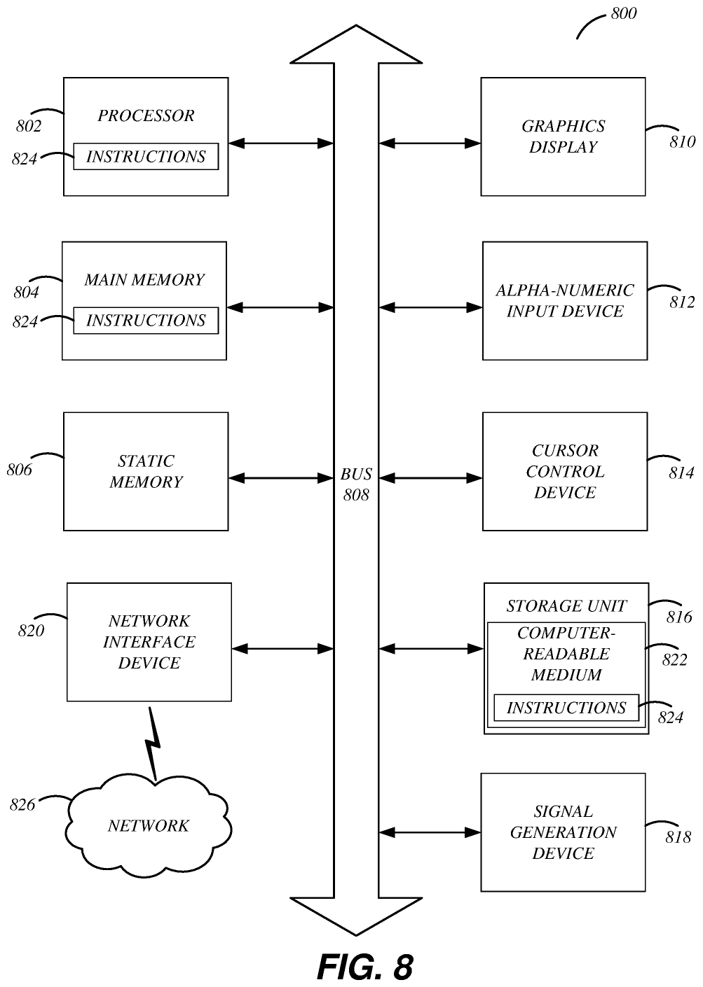

A computing device of the data management server 130 may take the form of software, hardware, or a combination thereof (e.g., some or all of the components of a computing machine of FIG. 8). For example, parts of the data management server 130 may be any machine capable of executing instructions that specify actions to be taken by that machine. Parts of the data management server 130 may include one or more processing units and a memory. Example components of the data management server 130 are described in further detail in FIG. 2.

A user device 140 may be controlled by a user who may be the customer of the blockchain unit publisher 110, the customer of the data management server 130, or a participant of the blockchain 150. In some situations, a user may also be referred to as an end user, for example, when the user is the data management server's customer who uses the platform provided by the data management server 130 to browse various blockchain units, such as a catalog of NFTs. In some situations, the blockchain unit publisher 110 and the blockchain unit owner 112 are also the users who possess the user devices 140. The user device 140 may be any computing device. Examples of user devices 140 include personal computers (PC), desktop computers, laptop computers, tablet computers, smartphones, wearable electronic devices such as smartwatches, or any other suitable electronic devices.

The user device 140 may include an application 142 and a user interface 144. The user interface 144 may be the interface of application 142 and allow the user to perform various actions associated with application 142. The application 142 may be operated by the data management server 130 to allow the user to view one or more blockchain data collections 122.

The user interface 144 may take different forms. In some embodiments, the user interface 144 is a software application interface. For example, the blockchain unit publisher 110 may provide a front-end software application that can be displayed on a user device 140. In one case, the front-end software application is a software application that can be downloaded and installed on a user device 140 via, for example, an application store (App store) of the user device 140. In another case, the front-end software application takes the form of a webpage interface of the blockchain unit publisher 110 that allows clients to perform actions through web browsers. The front-end software application includes a graphical user interface (GUI) that displays various information and graphical elements. In another embodiment, user interface 144 does not include graphical elements but communicates with the blockchain unit publisher 110 via other suitable ways such as command windows or application program interfaces (APIs).

A blockchain 150 may be a public blockchain that is decentralized, a private blockchain, or a semi-public blockchain. A public blockchain network includes a plurality of nodes that cooperate to verify transactions and generate new blocks. In some implementations of a blockchain, the generation of a new block may also be referred to as a mining process or a minting process. Some of the blockchains 150 support smart contracts, which are a set of code instructions that are stored on a blockchain 150 and are executable when one or more conditions are met. Smart contracts may be examples of autonomous program protocols 152. When triggered, the set of code instructions of a smart contract may be executed by a computer such as a virtual machine of the blockchain 150. Here, a computer may be a single operation unit in a conventional sense (e.g., a single personal computer) or may be a set of distributed computing devices that cooperate to execute the code instructions (e.g., a virtual machine or a distributed computing system). A blockchain 150 may be a new blockchain or an existing blockchain such as BITCOIN, ETHEREUM, EOS, NEO, SOLANA, AVALANCHE, etc. Data on the blockchain 150 may be stored in one or more ledgers 154 of the blockchain 150.

The autonomous program protocols 152 may be tokens, smart contracts, Web3 applications, autonomous applications, distributed applications, DeFi applications, protocols for DAO, NFTs, and other suitable protocols and algorithms that may be recorded on a blockchain. Depending on the type of blockchain 150 and implementation, the autonomous program protocol 152 is often a smart contract that includes automatically executable instructions stored on the blockchain 150. The autonomous program protocol 152 may specify how a blockchain unit, such as a cryptocurrency token or an NFT, may be generated. The autonomous program protocol 152 may also govern the transaction of the blockchain unit.

The communications among the blockchain unit publisher 110, blockchain unit owner 112, the data store 120, the data management server 130, the user device 140, and the blockchain 150 may be transmitted via a network 160, for example, via the Internet. In some embodiments, the network 160 uses standard communications technologies and/or protocols. Thus, the network 160 can include links using technologies such as Ethernet, 802.11, worldwide interoperability for microwave access (WiMAX), 3G, 4G, LTE, 5G, digital subscriber line (DSL), asynchronous transfer mode (ATM), InfiniBand, PCI Express Advanced Switching, etc. Similarly, the networking protocols used on the network 160 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 160 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The network 160 also includes links and packet switching networks such as the Internet.

### Example Data Management Server

FIG. 2 is a block diagram representing an example data management server 130, in accordance with some embodiments. In the embodiment shown in FIG. 2, the data management server 130 includes data collector engine 210, InterPlentary file system (IPFS) management engine 220, blockchain data collection management engine 230, cloud storage management engine 240, cryptographic key management engine 250, blockchain interfacing engine 260, front-end interface 270, and communication terminals 280. The functions of the data management server 130 may be distributed among different components in a different manner than described below. Also, in various embodiments, the data management server 130 may include different, fewer, and/or additional components.

While the data management server 130 is used in a singular form, the data management server 130 may include one or more computers that include one or more processors and memory. The memory may store computer code that includes instructions. The instructions, when executed by one or more processors, cause the processors to perform one or more processes described herein. The data management server 130 may take different forms. In one embodiment, the data management server 130 is a single computer that executes code instructions directly. In another embodiment, the data management server 130 is a group of computing devices that communicate with each other. The computing devices may be located geographically at the same (e.g., in a server room) or in different locations. In yet another embodiment, the data management server 130 includes multiple nodes that operate in a distributed fashion such as in cloud computing or distributed computing. Each node may include one or more computing devices operating together. For example, in some embodiments, the data management server 130 is decentralized and is operated by different nodes cooperatively to form the data management server 130. In some cases, the data management server 130 may also include virtual machines. Any computing devices, nodes, virtual machines, singular or plural, may simply be referred to as a computer, a computing device, or a computing server. Components of the data management server 130 shown in FIG. 2, individually or in combination, may be a combination of hardware and software and may include all or a subset of the example computing system illustrated and described in FIG. 8.

The data collector engine 210 may collect various types of data related to a blockchain unit, whether the data is on-chain or off-chain. Using an NFT as an example of the blockchain unit, the data to be collected may include asset-related metadata such as the name, description, asset URI, token identifier, etc. Some of the asset-related metadata may be on-chain data while other metadata resides in an asset URI that may be a token URI. The token URI often contains metadata of the NFT and may take the form of a structured key-value pair file such as a JSON file that resides off-chain. The token URI may also point to the URI of the asset itself. In some embodiments, the data to be collected by the data collector engine 210 may also include transaction metadata such as the current owner blockchain address, the new owner blockchain address, the price of the transfer of the blockchain unit, the quantity of the unit (if the unit is fungible), the purchase date and time, and transaction identifiers. The transaction metadata are often on-chain data. In some embodiments, the data to be collected by the data collector engine 210 may also include the metadata related to the autonomous program protocol 152 (e.g., smart contract metadata) such as the contract address, the contract identifier, multisignature requirements, etc. In some embodiments, the data to be collected by the data collector engine 210 may also include the assets such as digital art, video, music, contract, etc.

The data collector engine 210 may collect the data related to the blockchain unit using different processes. For example, the data management server 130 may include a component that serves as a node of the blockchain 150 or use any public or private API access to the blockchain 150 to obtain on-chain data. For example, the data collector engine 210 may obtain the token identifier and smart contract address of the NFT via blockchain nodes, public APIs, adapters, the webpage of the NFT, etc. Off-chain data may be obtained via APIs, or any permissible way to access the data. The data related to a blockchain unit can be collected based on frequency or based on triggers (e.g., a new block is added to the chain). The data collector engine 210 may capture the incremental changes on the blockchain 150 as older blocks on the blockchain 150 cannot be changed.

The IPFS management engine 220 may serve as a node of an IPFS peer-to-peer network system. The data collected by data collector engine 210 may be stored at a data store 120, which may take the form of an IPFS in some embodiments. The filesystem of IPFS provides peer-to-peer distribution of the data to complement the decentralized nature of the applications. IPFS may provide a permanent record of the blockchain unit related data at a particular point in time when the data was collected. IPFS may facilitate metadata and storage immutability.

By way of example, the IPFS management engine 220 may store the collected data related to a blockchain unit using IPFS for immutability. IPFS generates a fingerprint (e.g., a cryptographic hash) a data block related to a blockchain unit. The fingerprint may be referred to as a content identifier (CID). The CID may serve as a permanent record of the data at the point in time of storage and may be dependent on the physical storage where the data resides. The IPFS nodes may be deployed off-chain on the Cloud. Since the IPFS network is distributed, the data related to the blockchain unit may be stored and replicated across regions to maintain multiple copies to keep the data accessible. As new data related to the blockchain unit is captured by the data collector engine 210 (e.g., when a new transaction related to the blockchain unit is recorded on the blockchain 150 or the blockchain unit owner updates metadata related to the unit), a new block of data is stored using IPFS. The IPFS generates a new CID. Both the new block of data and the new CID may be stored off-chain on the Cloud. A unique IPFS uniform resource locator (URL) may also be generated. In some embodiments, the unique IPFS URL and the associated CID are stored on the Cloud with a key-value store.

In some embodiments, the use of IPFS to store the blockchain unit related data ensures the integrity of the data. Since IPFS generates a fingerprint for a given block of data, if the blockchain unit related data changes, the fingerprint is not valid anymore and a new CID is generated. Hence, data integrity is guaranteed to prevent the data from being tampered. When the data is modified, the CID of the data changes.

The blockchain data collection management engine 230 aggregates the data collected by the data collector engine 210 to generate a data collection associated with a blockchain unit. The data collection may include a list of entries of transactions associated with the blockchain unit. The entries of transactions may include the initial entry that records the creation of the blockchain unit such as the creation of the NFT. For example, the initial entry may include the asset itself, the identifier and address of the smart contract, the token URI, etc. The data collector engine 210 collects the data from different sources, on-chain or off-chain, and the blockchain data collection management engine 230 may aggregate those data to make a single entry. Subsequent to the creation of the blockchain unit, the data collector engine 210 may continue to collect data related to updates of the blockchain unit. For example, there can be transactions on the blockchain 150 showing that the ownership of the blockchain unit has changed. The data collector engine 210 collects the transaction record and a new entry of transaction is created by the blockchain data collection management engine 230.

The blockchain data collection management engine 230 may store the list of entries of transactions related to the blockchain unit at the data store 120. The data store 120 may take different forms such as conventional Cloud storage, a local storage, or an IPFS. In the embodiments that use the IPFS, each entry of transaction may be stored as a data block that is associated with a unique CID. As such, the data collection of the blockchain unit may include a list of CIDs that each corresponds to a particular entry of transaction. In some embodiments, a conventional Cloud storage is used and the entries of transactions may be stored in an off-chain manner that complies with the standard of the Cloud storage system.

The cloud storage management engine 240 provides management of the blockchain data collections 122 that are stored in a data store 120, whether the data store 120 is an IPFS or other Cloud storage system. The cloud storage management engine 240 provides functionalities and capabilities that are typically not possible when the data, especially the on-chain data, are scattered among different locations on the blockchain 150 or other locations. The cloud storage management engine 240 may provide encryption of data, a convenient method to retrieve records related to a particular blockchain unit, replication, scaling, analytics, indexing, and caching.

By way of example, the cloud storage management engine 240 may store the encrypted private key 124 so that sensitive information (e.g., the underlying asset of an NFT) may be encrypted using the double private key envelope encryption that is discussed above.

In some embodiments, the cloud storage management engine 240 may also generate an off-chain address for a user to retrieve a data collection associated with a blockchain unit. For example, the off-chain address may take the form of a master-level address of a namespace and the entries of transactions are stored under the namespace. The namespace may take different forms. In some embodiments, the namespace is a global namespace that can be accessed without a particular system or file structure. For example, the global namespace may be a URL or a website address that can be accessed through a generic web browser. In some embodiments, the namespaces may be under the system of the data management server 130 and a user may browser records of various blockchain units via a platform provided by the data management server 130.

In some embodiments, the cloud storage management engine 240 may use a global namespace in combination with IPFS to manage the data collections of various blockchain units. By way of example, entries of transactions of a blockchain unit may be stored using IPFS so that each entry is associated with its own CID. The CIDs are grouped under the same unique URL that serves as the global namespace. As such, the data collection provides a history of the blockchain unit and an additional CID denotes a change to the blockchain unit's data or metadata. In some embodiments, the global namespace may be generated based on the underlying asset of an NFT. If the NFT asset itself is changed, the cloud storage management engine 240 may regard this as a new NFT and generates a new URL for the access of records related to the new asset. The unique URL, which may act as a global namespace, is location agnostic (irrespective of the Cloud vendor). The URLs of various NFTs may be generated as content-based addresses.

The cloud storage management engine 240 may also provide other capabilities that are related to data management. For example, the cloud storage management engine 240 may index the entries of transactions (including metadata) of various blockchain units so that the records are easily searchable and retrievable. The data, including smart contract details, may also be cached based on access needs to provide fast access to data. The cloud storage management engine 240 may also provide analytics of the data collections of various blockchain units so that the blockchain units may be ranked, sorted, and/or filtered based on analytics such as popularity, tags, keywords, types, etc.

The cryptographic key management engine 250 stores and manages one or more cryptographic keys for encryption purposes and other purposes, such as allowing the data management server 130 to participate in various blockchains and to generate digital signatures for requests to access autonomous program protocols 152. For example, the cryptographic key management engine 250 may store the encrypted private key 124 that is used to access sensitive information of the data collections 122 associated with a blockchain unit. Additionally, or alternatively, the cryptographic key management engine 250 may store various private cryptographic keys of the data management server 130. In some embodiments, the data management server 130 may use master private cryptographic keys for different autonomous program protocols 152. In some embodiments, for each autonomous program protocol 152, the cryptographic key management engine 250 may generate a new pair of private and public cryptographic keys. The cryptographic key management engine 250 keeps the private cryptographic key secret and may publish the public cryptographic key to be included in the autonomous program protocol 152, at a location on the blockchain 150, or at a certificate authority. In some embodiments, the data management server 130 may also participate in activities of various blockchains 150, such as performing transactions on blockchains 150. For a blockchain 150, the cryptographic key management engine 250 may maintain one or more private keys to allow the data management server 130 to generate blockchain addresses of the data management server 130 and to validate that data management server 130 owns the blockchain units that are connected to one or more public cryptographic keys of the data management server 130. In various embodiments, a blockchain address of the data management server 130 may be generated by a series of one or more one-way functions from the public key, which is generated from the private key. The cryptographic key management engine 250 may derive a blockchain address by hashing the public key, adding prefixes, suffixes, and/or versions to the hash or the public key, creating a checksum, and/or encoding a derived result.

The blockchain interfacing engine 260 provides various functionalities for the data management server 130 to perform activities on different blockchains 150 that may have their own standards and protocols. The data management server 130 may serve as a node of a blockchain 150 to participate in the mining, minting and data validation process. The blockchain interfacing engine 260 allows data management server 130 to broadcast various transactions to a blockchain network for recordation. The blockchain interfacing engine 260 also routinely checks new blocks generated in various blockchains to check whether pending blockchain transactions or actions have been confirmed on the blockchains 150. New data related to a blockchain unit may be parsed from the new blocks and added to the data collection 122.

The blockchain interfacing engine 260 may include a smart contract engine that manages the generation and triggering of various smart contracts that are recorded on different blockchains. A smart contract may be created through a particular programming language that is compatible with a blockchain 150. A smart contract is recorded on a block of the blockchain and may be immutable. The recorded smart contract may include executable code instructions that are triggered by a certain condition. When the condition is met and verified, the code instructions are executed by a computer to automatically execute the contract terms that take the form of code instructions. The computer that executes the smart contract may take various forms. For example, a computer described herein may be a conventional personal computer, a virtual machine for the blockchain, or even a collection of distributed nodes in distributed computing. When the code instructions of the smart contract are executed, the code instructions may cause certain events (e.g., a transaction, a generation of a token, creation of new information) to be recorded on a blockchain.

The blockchain interfacing engine 260 may also include an oracle machine that may serve as a data feed for an autonomous program protocol 152. The oracle machine may receive different data from various sources. For example, different parties may provide information and data to the oracle machine. When relevant information is obtained by the oracle machine, some code instructions of the autonomous program protocol 152 may be triggered if certain conditions are met.

The data management server 130 may include one or more front-end interfaces 270. A front-end interface 270 allows the data management server 130 to provide a platform for users to retrieve and review data collections 122 related to various blockchain units. In some embodiments, the data management server 130 may provide a platform that may be used to browse various NFTs. In some embodiments, the platform may serve as a marketplace for various NFTs and includes historical records of the NFTs. The front-end interface 270 may take different forms. A first example of front-end interface 270 is a software application interface that is installed on a user device 140 such as smartphones and computers. A second example front-end interface 270 is a webpage interface of the data management server 130 that allows users to manage their accounts through web browsers. A third example front-end interface 270 is an application program interface (API) of the data management server 130 that allows users to perform actions through program codes and algorithms.

The communication terminal 280 of the data management server 130 provides network and blockchain connections between the data management server 130 and various entities that communicate with the data management server 130. The data management server 130 may serve as a node of various public blockchains to participate in various mining and block validation processes. When the data management server 130 initiates various actions through a blockchain, the communication terminal 280 may broadcast transactions using the public key of the data management server 130 or the public key of users to the network of the blockchain for recordation. The broadcast transactions are recorded in one or more newly generated blocks in the blockchain and are verified after multiple subsequent blocks are linked to the block that records the transactions. The data management server 130 may include different terminals such as blockchain terminal, asset exchange terminal, and messaging application terminal. Each terminal may manage a data feed or a webpage that publishes information regarding the related services and server status. Each terminal may also include its individual API.

### Example Blockchain Data Collection Generating Process

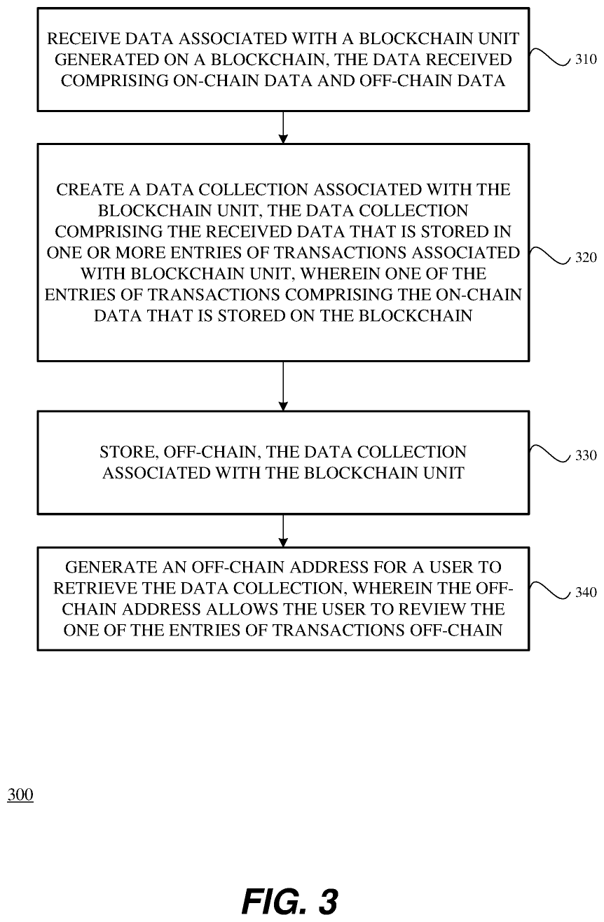

FIG. 3 is a flowchart depicting an example process 300 for generating a data collection associated with a blockchain unit, in accordance with some embodiments. The process 300 may be performed by a computing device, such as data management server 130, which is used in this figure as the example computing device. The process 300 may be embodied as a software algorithm that may be stored as computer instructions that are executable by one or more processors. The instructions, when executed by the processors, cause the processors to perform various steps in the process 300. In various embodiments, the process 300 may include additional, fewer, or different steps.

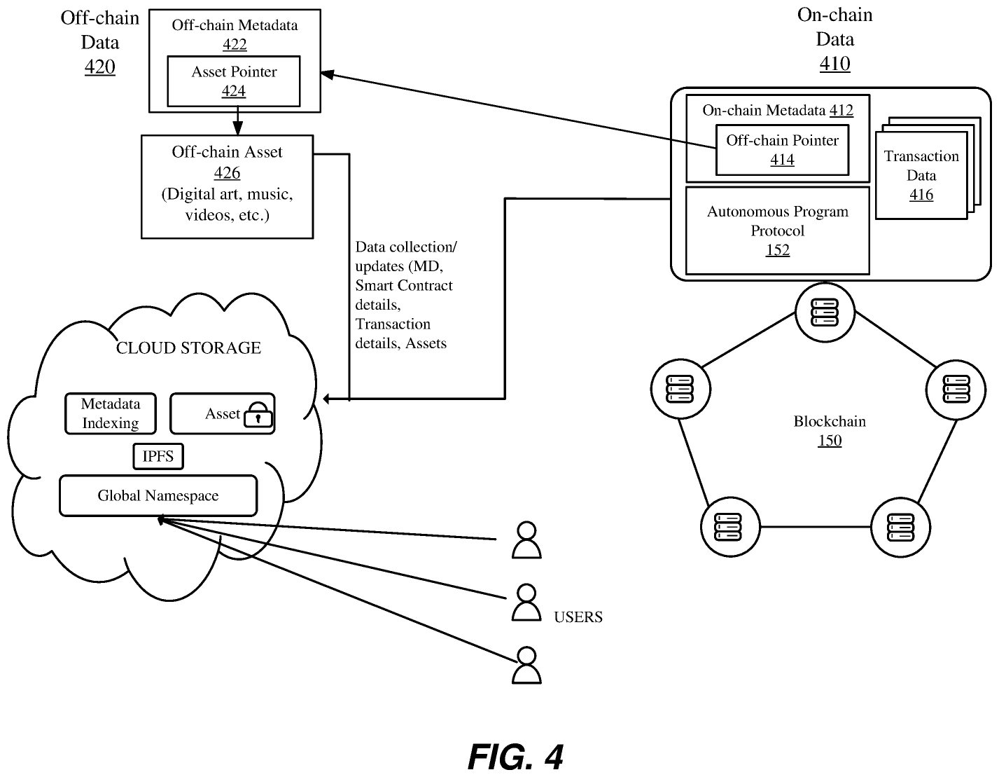

FIG. 4 is a block diagram that conceptually illustrates the migration of data and generation of data collections, in accordance some embodiments. FIG. 4 graphically illustrates some of the process 300 that is described in FIG. 3. FIG. 5 is a conceptual diagram illustrating an example of a data collection 500 under a namespace, in accordance with some embodiments. The data collection 500 illustrated in FIG. 5 is merely an example to illustrate one potential data structure of the data collection 500. FIG. 3, FIG. 4, and FIG. 5 are discussed together.

In some embodiments, the data management server 130 may receive 310 data associated with a blockchain unit generated on a blockchain 150. As discussed in FIG. 1, the blockchain unit can be any suitable blockchain unit, such as an NFT. The data management server 130 may receive the data from various sources via different methods, as discussed in FIG. 2 in association with the data collector engine 210. The sources of data may be directly from the blockchain 150 or various off-chain sources, such as locations to which a record on the blockchain 150 points, websites related to the blockchain unit, manual uploads from the blockchain unit publisher 110 or blockchain unit owner 112, etc. The data management server 130 may receive 130 the data by actively parsing any data records from the blockchain 150 or another data source or passively receiving data from someone who uploads the data manually or through an API.

The data received by the data management server 130 may include on-chain data 410 and off-chain data 420. As shown in FIG. 4, some on-chain data 410 may be recorded on the blockchain 150. For example, the blockchain unit is generated through an autonomous program protocol 152 stored on the blockchain 150. Inside the code of the autonomous program protocol 152 or at another on-chain record that is linked to the autonomous program protocol 152, there can be a set of on-chain metadata 412 identifying the basic information of the blockchain unit. The on-chain metadata 412 may include an off-chain pointer 414 that points to an off-chain metadata location 422 where additional metadata of the blockchain unit is stored. The off-chain metadata location 422 may sometimes be referred to as the token URI. The off-chain metadata location 422 may include an asset pointer 424 that includes an off-chain address of the underlying asset 426 related to the blockchain unit. The asset 426 may be digital art, music, video, or other content and may be encrypted.

The types of on-chain metadata and off-chain metadata illustrated in FIG. 4 is an example only. Whether a precise piece of information is stored on-chain or off-chain may depend on the embodiments and the design choice of the blockchain unit publisher 110. For example, while the asset pointer 424 is illustrated as being stored off-chain in the off-chain metadata location 422, in other embodiments the asset pointer 424 may also be stored directly on blockchain 150. Likewise, the asset 426 may also be stored directly on blockchain 150. Also, in some embodiments, if the blockchain unit is fungible, there may not be an asset 426 that represents a piece of content being stored off-chain. The precise types of metadata and the locations of metadata may vary from embodiment to embodiment.

By way of example, the received on-chain data may include the metadata related to the blockchain unit recorded on the blockchain 150, the blockchain address of the autonomous program protocol 152 (e.g., the address of the smart contract), the blockchain address of the blockchain unit, etc. In some embodiments, the data management server 130 may also store a copy of the entire autonomous program protocol 152 and any records related to the blockchain unit. In some embodiments, the autonomous program protocol 152 may also govern the transactions related to the blockchain unit. For example, the autonomous program protocol 152 may generate transaction 416 of the blockchain unit when the blockchain unit is assigned from a first blockchain address to another blockchain address (e.g., in the event of a change of ownership). The received on-chain data may include transaction data 416 associated with the usage of the autonomous program protocol 152.

In some embodiments, the received off-chain data may include data that is stored outside of the blockchain 150. Examples of the off-chain data may include data of an asset, metadata associated with the asset, a token uniform resource identifier (token URI), and off-chain metadata. The data management server 130 may also store data that is relevant but is not directly describe the blockchain unit. For example, the data management server 130 may parse news, website description, discussions, and other information that is related to the blockchain unit from different sources such as websites and other Internet sources.

In some embodiments, the data management server 130 may create 320 a data collection associated with the blockchain unit. The data collection may include the received data, whether the data is on-chain or off-chain. The data collection may include one or more entries of transactions associated with the blockchain unit. The data management server 130 may aggregate the on-chain data and the off-chain data to generate an entry of transaction. For example, one of the entries may be the initial entry that stores the address of the autonomous program protocol 152, the off-chain pointer 414, the asset pointer 424, and the actual data of the asset 426 that are compiled from various on-chain and off-chain data. Subsequent entries may correspond to records that document the change of the blockchain unit, such as transaction records that are recorded on the blockchain 150. In various embodiments, one or more entries of transactions may include at least some on-chain data 410 that is originally stored on the blockchain 150 and is duplicated off-chain in a data store 120.

In some embodiments, the data management server 130 may store 330, off-chain, the data collection associated with the blockchain unit. For example, the data collection may be stored in the data store 120. The precise storage mechanism may depend on embodiments. In some embodiments, part of the data collection may be stored using double private key envelope encryption. For example, the original asset owner (e.g., the content creator) may upload the asset 426 to the data management server 130. The data management server 130 may encrypt the asset 426 using a private key. The encryption private key may further be encrypted by the asset owner's private key. The transfer of data may be achieved by transferring the asset owner's private key. In some embodiments, some or all of the entries of transactions in the data collection may be stored using IPFS so that the entry records become immutable.

In some embodiments, the data management server 130 may generate 340 an off-chain address for a user to retrieve the data collection. The off-chain address allows the user to review one of the entries of transactions off-chain. The off-chain address may take different forms. In some embodiments, the data management server 130 may provide a front-end interface 270 for end users to browse different blockchain units. For example, the front-end interface 270 may serve as a marketplace or catalog of NFTs. The off-chain address may be an internal address that is used by the platform provided by the data management server 130 to reach the blockchain unit's record page.

In some embodiments, the off-chain address may be an address that may serve as a global namespace. An example structure of the data collection 500 is shown in FIG. 5. In this example, the off-chain address 510 may take the form of a master-level address of a namespace. In some embodiments, part of the off-chain address 510 may include a content-based portion 512, which may be generated from the underlying asset. For example, the content-based portion 512 may be a fingerprint of the asset so that the address of the data collection 500 is tied to the asset. If the asset changes, the off-chain address 510 will change and the data management server 130 will treat the blockchain unit that has two different assets as two different data collections 500. The entries of transactions are stored as content identifiers (CID) 520 that are listed under the namespace. The data collection under the namespace may also show other metadata such as the date and time of entry that was created, the order of the entries, the sizes of the entries, etc. (other metadata examples not shown in FIG. 5). The CID 520 may be generating by generating a fingerprint of the underlying data of the entry of transaction. Within each entry of the transaction, the data may take the form of key-value pairs that are in the format of JSON, XML, YAML, CSV, or another suitable format. For example, in entry 530, the entry represents an initial entry of the blockchain unit. The entry 530 includes key identification information of the blockchain unit such as the smart contract address that creates the blockchain unit, the token URI, the asset pointer, etc. Entry 540 may be another example transaction record that documents a subsequent transaction. The transaction may be a change of ownership of the blockchain unit. The key-value pairs may include the original owner's address, the new owner's address and other information involved in the transaction, such as the price of the purchase.

The data management server 130 may also perform other data management tasks related to the data collection. For example, the data collection may be stored in a cloud storage system. The entries of transactions of the data collection may be indexed in the cloud storage system so that the data is quickly searchable. In some embodiments, certain key data may also be cached for fast access.

### Example Sequence Diagram

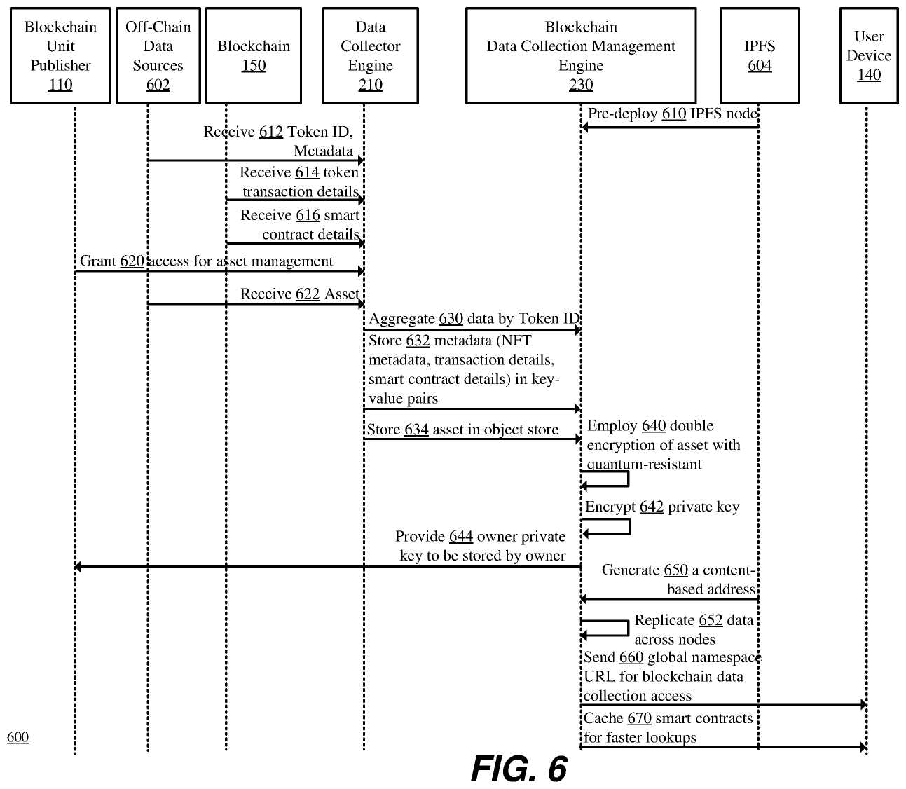

FIG. 6 is a sequence diagram illustrating an example series 600 of interactions among entities of the system environment 100 to generate data collection for a blockchain unit, in accordance with some embodiments. The series 600 illustrated in FIG. 6 represents specific sets of instructions that may be stored in one or more computer-readable media, such as memory of different devices. The instructions, when executed by one or more processors of the depicted entities, cause one or more processors to perform the described interactions. As depicted in FIG. 6, the series 600 is performed by blockchain unit publisher 110, one or more off-chain data sources 602, the blockchain 150, the data management server 130 that includes the data collector engine 210 and the blockchain data collection management engine 230, an IPFS 604, and a user device 140. The series 600 is illustrated using IPFS 604 as an example of the data store 120 and an NFT as an example of the blockchain unit. In various embodiments, other types of blockchain units and Cloud storage systems may also be used. The sequence of interactions depicted in FIG. 6 is merely an example of the sequence of interactions, and in other embodiments, the sequence of interactions may include fewer, additional, or different actions performed by the same or different entities. While the steps in series 600 are illustrated graphically in FIG. 6 as sequences of steps, some of the steps may occur in different sequences than illustrated or may occur concurrently with other steps.

In some embodiments, the blockchain data collection management engine 230 of the data management server 130 may pre-deploy 610 as an IPFS node of the IPFS 604. The data collector engine 210 may receive 612 a token identifier and metadata of the blockchain unit from the off-chain data sources 602. All of the off-chain data may be stored in a single off-chain data source 602 or the off-chain data may be collected from different sources. The data collector engine 210 may receive 614 token transaction details from the blockchain 150. The transaction details may be one or more transaction records that are stored on the blockchain 150. The data collector engine 210 may also receive 616 smart contract details related to the NFT.

In some embodiments, the data management server 130 may also be delegated by the blockchain unit publisher 110 to manage the underlying asset of the NFT. For example, the blockchain unit publisher 110 may grant access 620 for asset management to the data collector engine 210. The grant of access may include information such as the location of the asset. If the asset is encrypted, the blockchain unit publisher 110 may also transmit a decryption key to the data management server 130 or may decrypt the asset before the asset is transmitted. In turn, the data collector engine 210 receives 622 the asset from an off-chain data source 602.

The data collector engine 210 may aggregate 630 the received data by the token ID. In generating the data collection 122, the data collector engine 210 may store 632 the metadata, such as the NFT metadata, transaction details, smart contract details in key-value pairs. The data collector engine 210 may also store 634 the asset in an object store, such as AMAZON S3 and AMAZON GLACIER.

The blockchain data collection management engine 230 may perform additional steps to maintain or improve the security of the asset. For example, the blockchain data collection management engine 230 may employ 640 a double encryption to encrypt sensitive data such as the underlying asset. The double encryption may include generating a private key that is used to encrypt the asset. The generation of the private key may use any secured private key generation algorithm such as a quantum-resistant algorithm. The blockchain data collection management engine 230 may encrypt 642 the private key using an owner private key that is to be held by the asset owner, such as the blockchain unit publisher 110 when the NFT is first generated. The blockchain data collection management engine 230 may provide 644 the owner's private key to the blockchain unit publisher 110. The owner's private key is to be stored by the owner and passed to subsequent owners for access to the asset.

The IPFS 604 may generate 650 an address that is used to identify the data collection associated with a particular blockchain unit. The address may be content-based. For example, part of the address may be generated based on a fingerprint of the asset so that, if the underlying asset has changed, the address of the data collection will change. As such, the blockchain data collection management engine 230 will treat the changed asset as a different NFT that has a different address for the retrieval of the data collection. The blockchain data collection management engine 230 may replicate 652 the data collection across different nodes and regions.

For a user to access the data collection of a particular blockchain unit, the blockchain data collection management engine 230 may send 660 a global namespace URL for the access of blockchain data collection. The blockchain data collection management engine 230 may also cache 670 smart contracts for faster lookups.

### Example Blockchain Architecture

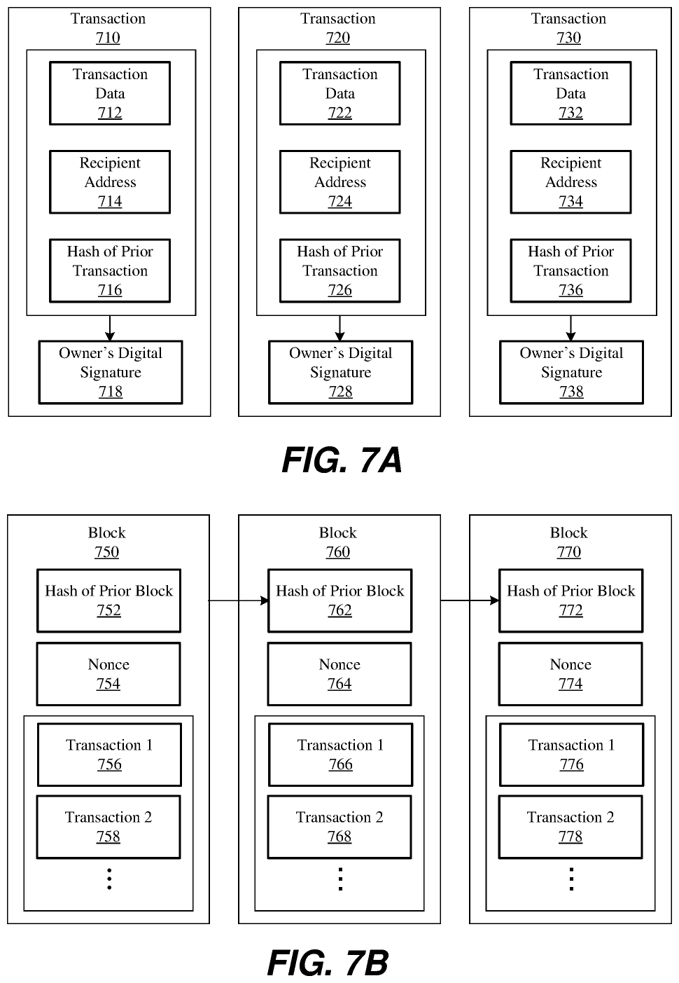

FIG. 7A is a block diagram illustrating a chain of transactions broadcasted and recorded on a blockchain, in accordance with an embodiment. The transactions described in FIG. 7A may correspond to any of the transactions and a transfer of any blockchain unit described in previous figures. The blockchain unit can be an NFT or any fungible tokens.

In some embodiments, a blockchain is a distributed system. A distributed blockchain network may include a plurality of nodes. Each node is a user or a server that participates in the blockchain network. In a public blockchain, any participant may become a node of the blockchain. The nodes collectively may be used as a distributed computing system that serves as a virtual machine of the blockchain. In some embodiments, the virtual machine or a distributed computing system may be simply referred to as a computer. Any users of a public blockchain may broadcast transactions for the nodes of the blockchain to record. Each user's digital wallet is associated with a private cryptographic key that is used to sign transactions and prove the ownership of a blockchain unit.

The ownership of a blockchain unit may be traced through a chain of transactions. In FIG. 7A, a chain of transactions may include a first transaction 710, a second transaction 720, and a third transaction 730, etc. Each of the transactions in the chain may have a fairly similar structure except the very first transaction in the chain. The first transaction of the chain may be generated by a smart contract, a mining process, or a minting process and may be traced back to the smart contract that is recorded on the blockchain or the first block in which it was generated. While a transaction may be linked to a prior transaction in FIG. 7A, the transaction does not need to be recorded on consecutive blocks on the blockchain. For example, the block recording the transaction 710 and the block recording the transaction 720 may be separated by hundreds or even thousands of blocks. Depending on the architecture of the blockchain, the traceback of the prior block may be tracked by the hash of the prior block that is recorded by the current block. In some embodiments, account model is used and transactions do not have any references to previous transactions. In those types of blockchains, transactions are not chained and do not contain the hash of the previous transaction.

Referring to one of the transactions in FIG. 7A, for illustration, the transaction 720 may be referred to as a current transaction. Transaction 710 may be referred to as a prior transaction and transaction 730 may be referred to as a subsequent transaction. Each transaction includes a transaction data 722, a recipient address 724, a hash of the prior transaction 726, and the current transaction's owner's digital signature 728. The transaction data 722 records the substance of the current transaction 720. For example, the transaction data 722 may specify a transfer of a quantity of a blockchain unit (e.g., a coin, a blockchain token, etc.). In some embodiments, the transaction data 722 may include code instructions of a smart contract.

The recipient address 724 is a version of the public key that corresponds to the private key of the digital wallet of the recipient. In one embodiment, the recipient address 724 is the public key itself. In another embodiment, the recipient address 724 an encoded version of the public key through one or more functions such as some deterministic functions. For example, the generation of the recipient address 724 from the public key may include hashing the public key, adding a checksum, adding one or more prefixes or suffixes, encoding the resultant bits, and truncating the address. The recipient address 724 may be a unique identifier of the digital wallet of the recipient on the blockchain.

The hash of the prior transaction 726 is the hash of the entire transaction data of the prior transaction 710. Likewise, the hash of the prior transaction 736 is the hash of the entire transaction data of the transaction 720. The hashing of the prior transaction 710 may be performed using a hashing algorithm such as a secure hash algorithm (SHA) or a message digest algorithm (MD). In some embodiments, the owner corresponding to the current transaction 720 may also use the public key of the owner to generate the hash. The hash of prior transaction 726 provides a traceback of the prior transaction 710 and also maintains the data integrity of the prior transaction 710.

In generating a current transaction 720, the digital wallet of the current owner of the blockchain unit may use its private key to encrypt the combination of the transaction data 722, the recipient address 724, and the hash of prior transaction 726 to generate the owner's digital signature 728. To generate the current transaction 720, the current owner specifies a recipient by including the recipient address 724 in the digital signature 728 of the current transaction 720. The subsequent owner of the blockchain unit is fixed by the recipient address 724. In other words, the subsequent owner that generates the digital signature 738 in the subsequent transaction 730 is fixed by the recipient address 724 specified by the current transaction 720. To verify the validity of the current transaction 720, any nodes in the blockchain network may trace back to the prior transaction 710 (by tracing the hash of prior transaction 726) and locate the recipient address 714. The recipient address 714 corresponds to the public key of the digital signature 728. Hence, the nodes in the blockchain network may use the public key to verify the digital signature 728. Hence, a current owner who has the blockchain unit tied to the owner's blockchain address can prove the ownership of the blockchain unit. In this disclosure, it can be described as the blockchain unit being connected to a public cryptographic key of a party because the blockchain address is derived from the public key.

The transfer of ownership of a blockchain unit may be initiated by the current owner of the blockchain unit. To transfer the ownership, the owner may broadcast the transaction that includes the digital signature of the owner and a hash of the prior transaction. A valid transaction with a verifiable digital signature and a correct hash of the prior transaction will be recorded in a new block of the blockchain through the block generation process.

FIG. 7B is a block diagram illustrating a connection of multiple blocks in a blockchain, in accordance with an embodiment. Each block of a blockchain, except the very first block which may be referred to as the genesis block, may have a similar structure. The blocks 750, 760, and 760 may each include a hash of the prior blockchain 752, a nonce 754, and a plurality of transactions (e.g., a first transaction 756, a second transaction 758, etc.). Each transaction may have the structure shown in FIG. 7A.

In a block generation process, a new block may be generated through mining, or minting (e.g., voting). For a mining process of a blockchain, any nodes in the blockchain system may participate in the mining process. The generation of the hash of the prior block may be conducted through a trial and error process. The entire data of the prior block (or a version of the prior block such as a simplified version) may be hashed using the nonce as a part of the input. The blockchain may use a certain format in the hash of the prior block in order for the new block to be recognized by the nodes as valid. For example, in one embodiment, the hash of the prior block needs to start with a certain number of zeroes in the hash. Other criteria of the hash of the prior block may also be used, depending on the implementation of the blockchain.

In a minting process, the nodes in a blockchain system may vote to determine the content of a new block. Depending on the embodiment, a selected subset of nodes or all nodes in the blockchain system may participate in the votes. When there are multiple candidates new blocks that include different transactions are available, the nodes will vote for one of the blocks to be linked to the existing block. The voting may be based on the voting power of the nodes.

By way of example of a block generation process using mining, in generating the hash of prior block 762, a node may randomly combine a version of the prior block 750 with a random nonce to generate a hash. The generated hash is somewhat a random number due to the random nonce. The node compares the generated hash with the criteria of the blockchain system to check if the criteria are met (e.g., whether the generated hash starts with a certain number of zeroes in the hash). If the generated hash fails to meet the criteria, the node tries another random nonce to generate another hash. The process is repeated for different nodes in the blockchain network until one of the nodes finds a hash that satisfies the criteria. The nonce that is used to generate the satisfactory hash is the nonce 764. The node that first generates the hash 762 may also select what transactions that are broadcasted to the blockchain network are to be included in the block 760. The node may check the validity of the transaction (e.g., whether the transaction can be traced back to a prior recorded transaction and whether the digital signature of the generator of the transaction is valid). The selection may also depend on the number of broadcasted transactions that are pending to be recorded and also the fees that may be specified in the transactions. For example, in some embodiments, each transaction may be associated with a fee (e.g., gas) for having the transaction recorded. After the transactions are selected and the data of the block 760 is fixed, the nodes in the blockchain network repeat the trial and error process to generate the hash of prior block 772 by trying different nonce. In embodiments that use voting to generate new blocks, a nonce may not be needed. A new block may be linked to the prior block by including the hash of the prior block.

New blocks may be continued to be generated through the block generation process. A transaction of a blockchain unit (e.g., an electronic coin, a blockchain token, etc.) is complete when the broadcasted transaction is recorded in a block. In some embodiments, the transaction is considered settled when the transaction is considered final. A transaction is considered final when there are multiple subsequent blocks generated and linked to the block that records the transaction.

In some embodiments, some of the transactions 756, 758, 766, 768, 776, 778, etc. may include one or more smart contracts. The code instructions of the smart contracts are recorded in the block and are often immutable. When conditions are met, the code instructions of the smart contract are triggered. The code instructions may cause a computer (e.g., a virtual machine of the blockchain) to carry out some actions such as generating a blockchain unit and broadcasting a transaction documenting the generation to the blockchain network for recordation.

### Computing Machine Architecture

FIG. 8 is a block diagram illustrating components of an example computing machine that is capable of reading instructions from a computer-readable medium and executing them in a processor. A computer described herein may include a single computing machine shown in FIG. 8, a virtual machine, a distributed computing system that includes multiple nodes of computing machines shown in FIG. 8, or any other suitable arrangement of computing devices.

By way of example, FIG. 8 shows a diagrammatic representation of a computing machine in the example form of a computer system 800 within which instructions 824 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 8 may correspond to any software, hardware, or combined components shown in FIG. 1, including but not limited to, the blockchain unit publisher 110, the data management server 130, the user device 140, a node of a blockchain network, and various engines, modules interfaces, terminals, and machines in various figures. While FIG. 8 shows various hardware and software elements, each of the components described in FIG. 1 may include additional or fewer elements. By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 824 that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processors (generally, processor 802) (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 804, and a static memory 806, which are configured to communicate with each other via a bus 808. The computer system 800 may further include graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or another pointing instrument), a storage unit 816, a signal generation device 818 (e.g., a speaker), and a network interface device 820, which also are configured to communicate via the bus 808.

The storage unit 816 includes a computer-readable medium 822 on which is stored instructions 824 embodying any one or more of the methodologies or functions described herein. The instructions 824 may also reside, completely or at least partially, within the main memory 804 or within the processor 802 (e.g., within a processor's cache memory) during execution thereof by the computer system 800, the main memory 804 and the processor 802 also constituting computer-readable media. The instructions 824 may be transmitted or received over a network 826 via the network interface device 820.

While computer-readable medium 822 is shown in an example embodiment to be a single medium, the term “computer-readable medium” should be taken to include a single medium or multiple media (e.g., a centralized or distributed database, or associated caches and servers) able to store instructions (e.g., instructions 824). The computer-readable medium may include any medium that is capable of storing instructions (e.g., instructions 824) for execution by the machine and that causes the machine to perform any one or more of the methodologies disclosed herein. The computer-readable medium may include, but not be limited to, data repositories in the form of solid-state memories, optical media, and magnetic media. The computer-readable medium does not include a transitory medium such as a signal or a carrier wave.

### Additional Configuration Considerations

Beneficially, with various embodiments described in this disclosure, the system allows transactions to continue to occur on the blockchain but provides a chain-agostic, storage-agnostic data management solution for blockchains. The use of Cloud storage provides easy lookups with less compute-intensive processes and maintains the cache off the chain for peripheral activities. Various embodiments save the chain's computing and storage resources for various lookups. The storage solution helps the chain resources be focused on transaction creation and not record management activities.

Various embodiments have different applications including searching, browsing, creating catalogs of the NFTs, smart contracts, and transaction details. Smart contract browsing can help creators look up contracts, or even choose the right contracts for their assets. Various embodiments are applicable for both non-fungible assets (unique) like NFTs and fungible assets like cryptocurrency. Even though in this disclosure examples are often discussed with the use of NFTs, various embodiments can be further expanded to other decentralized applications.

Certain embodiments are described herein as including logic or a number of components, engines, modules, or mechanisms. Engines may constitute either software modules (e.g., code embodied on a computer-readable medium) or hardware modules. A hardware engine is a tangible unit capable of performing certain operations and may be configured or arranged in a certain manner. In example embodiments, one or more computer systems (e.g., a standalone, client or server computer system) or one or more hardware engines of a computer system (e.g., a processor or a group of processors) may be configured by software (e.g., an application or application portion) as a hardware engine that operates to perform certain operations as described herein.

In various embodiments, a hardware engine may be implemented mechanically or electronically. For example, a hardware engine may comprise dedicated circuitry or logic that is permanently configured (e.g., as a special-purpose processor, such as a field programmable gate array (FPGA) or an application-specific integrated circuit (ASIC)) to perform certain operations. A hardware engine may also comprise programmable logic or circuitry (e.g., as encompassed within a general-purpose processor or another programmable processor) that is temporarily configured by software to perform certain operations. It will be appreciated that the decision to implement a hardware engine mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 802, that are temporarily configured (e.g., by software) or permanently configured to perform the relevant operations. Whether temporarily or permanently configured, such processors may constitute processor-implemented engines that operate to perform one or more operations or functions. The engines referred to herein may, in some example embodiments, comprise processor-implemented engines.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Upon reading this disclosure, those of skill in the art will appreciate still additional alternative structural and functional designs for a similar system or process through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

1. A computer-implemented method, comprising:
receiving data associated with a blockchain unit generated on a blockchain, the data received comprising on-chain data and off-chain data;
creating a data collection associated with the blockchain unit, the data collection comprising the received data that is stored in one or more entries of transactions associated with blockchain unit, wherein one of the entries of transactions comprising the on-chain data that is stored on the blockchain;
storing, off-chain, the data collection associated with the blockchain unit; and
generating an off-chain address for a user to retrieve the data collection, wherein the off-chain address allows the user to review the one of the entries of transactions off-chain.

2. The computer-implemented method of claim 1, wherein the received data associated with the blockchain unit comprises data of an asset, a token uniform resource identifier (token URI), and a smart contract address.

3. The computer-implemented method of claim 1, wherein the blockchain unit is a non-fungible token (NFT).

4. The computer-implemented method of claim 1, wherein the blockchain unit is generated through an autonomous program protocol stored on the blockchain, and the received on-chain data comprises transaction data associated with usage of the autonomous program protocol.

5. The computer-implemented method of claim 1, wherein the off-chain data comprises an asset and metadata associated with the asset.

6. The computer-implemented method of claim 1, wherein at least one of the entries of transaction in the data collection is stored using InterPlanetary File System (IPFS).

7. The computer-implemented method of claim 1, wherein the off-chain address is a master level address of a namespace and the entries of transactions are stored as content identifiers of InterPlanetary File System (IPFS) under the namespace.

8. The computer-implemented method of claim 7, wherein the namespace is a global namespace.

9. The computer-implemented method of claim 1, wherein the blockchain unit is associated with an asset that is stored off-chain, the asset is encrypted by a first private key, and the first private key is encrypted by a second private key that is possessed by an owner of the asset.

10. The computer-implemented method of claim 1, wherein the data collection is stored in a cloud storage system, and the entries of transactions of the data collection are indexed in the cloud storage system.

11. A system, comprising:
a blockchain that is configured to store on-chain data; and
a computing server, the computing server comprising memory and one or more processors, the memory storing code comprising instructions, wherein the instructions, when executed by the one or more processors, cause the one or more processors to:
receive data associated with a blockchain unit generated on the blockchain, the data received comprising the on-chain data and off-chain data;
create a data collection associated with the blockchain unit, the data collection comprising the received data that is stored in one or more entries of transactions associated with blockchain unit, wherein one of the entries of transactions comprising the on-chain data that is stored on the blockchain;
store, off-chain, the data collection associated with the blockchain unit; and
generate an off-chain address for a user to retrieve the data collection, wherein the off-chain address allows the user to review the one of the entries of transactions off-chain.

12. The system of claim 11, wherein the received data associated with the blockchain unit comprises data of an asset, a token uniform resource identifier (token URI), and a smart contract address.

13. The system of claim 11, wherein the blockchain unit is a non-fungible token (NFT).

14. The system of claim 11, wherein the blockchain unit is generated through an autonomous program protocol stored on the blockchain, and the received on-chain data comprises transaction data associated with usage of the autonomous program protocol.

15. The system of claim 11, wherein the off-chain data comprises an asset and metadata associated with the asset.

16. The system of claim 11, wherein at least one of the entries of transaction in the data collection is stored using InterPlanetary File System (IPFS).

17. The system of claim 11, wherein the off-chain address is a master level address of a namespace and the entries of transactions are stored as content identifiers of InterPlanetary File System (IPFS) under the namespace.

18. The system of claim 17, wherein the namespace is a global namespace.

19. The system of claim 11, wherein the blockchain unit is associated with an asset that is stored off-chain, the asset is encrypted by a first private key, and the first private key is encrypted by a second private key that is possessed by an owner of the asset.

20. The system of claim 11, wherein the data collection is stored in a cloud storage system, and the entries of transactions of the data collection are indexed in the cloud storage system.
